(19) United States
(12) Patent Application Publication
(10) Pub. No.: US 2012/0050046 A1
(43) Pub. Date: Mar. 1, 2012

(54) SYSTEMS AND METHODS FOR MONITORING PHYSICAL, BIOLOGICAL AND CHEMICAL CHARACTERISTICS OF A PERSON, ANIMAL, OBJECT AND/OR SURROUNDING ENVIRONMENT

(75) Inventor: Duane Anthony Satorius, Highland, MD (US)

(73) Assignee: Harris Corporation, Melbourne, FL (US)

(21) Appl. No.: 12/873,813

(22) Filed: Sep. 1, 2010

(51) Int. Cl. G08B 23/00; H04B 7/00; H04W 4/12; G05B 19/02

(52) U.S. Cl. 340/573.1; 455/41.3; 455/466

(57) ABSTRACT

Systems (100) and methods (500, 600) for monitoring at least one dynamic characteristic (DC) of a surface or surrounding environment. An RFID Tag and Sensor Module (RFID-TSM) is disposed on a surface. The RFID-TSM (108₁, . . . , 108_{N}) collects information relating to DC. A communication device (CD) is disposed within a communications range of DC. CD (102) comprises an RFID reader (104) and customizable software application (258). The RFID-TSM senses DC and communicates data relating to DC to CD. CD determines if a condition exits using the data and software application. In response to the existence of the condition, an operation is performed by CD using the software application. The operation can involve communicating the data and other information to at least one external device (112, 116) that is remote from CD. The condition, operation, information and external device can be defined by a consumer during a user-interactive session.

### BACKGROUND OF THE INVENTION

1. Statement of the Technical Field

The inventive arrangements relate to communication systems, and more particularly to systems and methods for monitoring physical, biological and chemical characteristics of a person, animal, object and/or surrounding environment.

2. Description of the Related Art

There is a growing need for a device that will automatically monitor and/or record a person's dynamic biometric data (such as a heart rate, blood pressure, glucose level, etc.). The increasing need at least partially results from the number of people that do not wish to be bothered with taking their blood pressure, pricking their finger to see if their glucose level is normal, or remembering to take their medication. In some cases, the individuals fail to remember to test themselves or take their medication. Other individuals are physically unable to test their biological characteristics. As such, various medical alert systems have been created to assist individuals with monitoring their health.

One such conventional medical alert system comprises a medical alert device worn by a user. The medical alert device transmits a message to a base station in response to the depression of a button thereof by the user. Upon receipt of the message, the base station transmits one or more messages to an emergency center. This described conventional medical alert system suffers from certain drawbacks. For example, the medical alert device does not detect health conditions of the person wearing the device. As such, medical conditions of the person wearing the device can not be analyzed in real time by medical personal at the emergency center. Also, the medical alert device requires internal circuitry and a battery. Consequently, the medical alert device is cumbersome, expensive and unreliable. In addition, the person wearing the medical alert device may not be physically able to press the button for help at the needed time, rendering the device useless.

Another such conventional medical alert system comprises sensors and a transfer unit that are both worn by a person. The sensors detect health conditions of the person wearing the sensors. Information describing the detected health conditions are communicated from the sensors to the transfer unit. The transfer unit processes the received information to detect health problems. If a health problem is detected, then the transfer unit relays a signal to another wireless device (e.g., a cellular phone). In turn, the wireless device (e.g., a cellular phone) calls a central emergency center and sends an emergency message to the central emergency center.

Despite the advantages of the second described medical alert system, it suffers from certain drawbacks. For example, static and/or dynamic biometric data is not transmitted from the transfer unit to the central emergency center. As such, medical conditions of the person wearing the device can not be stored and/or analyzed by the person and/or medical personal. Also, the sensors and transfer unit require internal circuitry and batteries. Consequently, the sensors and transfer unit are cumbersome, expensive and unreliable. Furthermore, the medical alert system is without a means for securing the biometric data from unauthorized access, and/or facilitating the customization of its features in accordance with the person's needs and/or desires.

Therefore, there is a need for an improved medical alert system. The improved medical alert system should be less cumbersome and expensive as compared to conventional medical alert systems. The improved medical alert system should also be more reliable than conventional medical alert systems. The improved medical alert system should also include a means for: tracking health conditions of persons; securing biometric data from unauthorized access; and/or facilitating the customization of its features in accordance with a person's needs and/or desires.

### SUMMARY OF THE INVENTION

Embodiments of the present invention generally concern implementing systems and methods for monitoring at least one dynamic characteristic of a body or surrounding environment. The body can be a body of a person, animal or object. The dynamic characteristic can be a changing physical characteristic, a changing biological characteristic or a changing chemical characteristic.

The methods generally involve performing, by a consumer, a user interactive session to customize a software application for controlling operations of a communication device (e.g., a smart phone). The software application is customized by: defining information to be output from the communication device; defining at least one condition, that is determinable using data relating to the dynamic characteristic, under which the communication device is to output the information; and identifying at least one external device that is intended to receive at least a portion of the information and is remote from the communication device.

The method also involves disposing at least one RFID Tag and Sensor Module (RFID-TSM) on a surface of a body. The RFID-TSM is configured to collect information relating to a dynamic characteristic of the surface of the body or a surrounding environment. The surface can be a surface of a person, an animal or an object. A communication device is located within communications range of the RFID-TSM. The communication device is a portable device including an RFID reader, a microprocessor or other suitable processor device, a memory and a customized software application. The RFID reader and other electronic components are coupled to the communication device via a peripheral device interface. Alternatively, the RFID reader and other electronic components can be disposed within a packet-sized housing or chassis of the communication device.

During operation, the RFID-TSM collects data relating to the dynamic characteristic of the surface of the body or surrounding environment. The data can be collected on a user-defined basis. The data is communicated from the RFID-TSM to the communication device.

At the communication device, the data is recorded and analyzed to determine if at least one condition exits. The'condition can be a condition defined by the consumer during the user-interactive session. The condition can include, but is not limited to, a medical condition, a hazardous condition, an intoxication and/or a mobility condition. The determination is made using the data received from the RFID-TSM and the software application. If the condition exits, then the communication device performs at least one operation using the software application. The operation can be an operation defined by the consumer during the user-interactive session.

The operation can advantageously involve: communicating the data relating to the dynamic characteristic to the external device; communicating a personalized alert message to the external device; communicating a control signal for controlling operations of the external device (e.g., a valve, a medicine injector, a vehicle or other machinery); and/or outputting an indication to take medication, and/or instructions how to improve the user-defined condition that has been determined to exist. The alert message can be a message personalized by the consumer during the user-interactive session. The personalized alert message can include at least one of an earcon message, an auditory message, an email message and/or a text message. The personalized alert message can also include at least one of a pre-recording of a person's voice, contact information of a person, static biometric data of a person (e.g., blood type and DNA), a timestamp, location information, directives and/or instructions.

According to an aspect of the present invention, the data relating to the dynamic characteristic is stored in memory of the communication device in a secure manner (e.g., an encrypted format and/or in a tamper-proof enclosure). The data can be recorded on a user-defined periodic basis. Access to the data can be restricted to only persons authorized by the consumer during the user-interactive session.

### BRIEF DESCRIPTION OF THE DRAWINGS

Embodiments will be described with reference to the following drawing figures, in which like numerals represent like items throughout the figures, and in which:

FIG. 1 is a schematic illustration of an exemplary system that is useful for understanding the present invention.

FIG. 2 is a block diagram of a communication device of FIG. 1 that is useful for understanding the present invention.

FIG. 3 is a schematic illustration of a person customizing software that is to be installed on the communication device of FIGS. 1-2.

FIG. 4 is a block diagram of a Radio Frequency Identification (RFID) tag and sensor module of FIG. 1 that is useful for understanding the present invention.

FIG. 5 is a flow diagram of an exemplary method for customizing a customizable software application that is useful for understanding the present invention.

FIGS. 6A-6B collectively provide a flow diagram of an exemplary method for monitoring conditions of a person, object, animal and/or surrounding environment that is useful for understanding the present invention.

### DETAILED DESCRIPTION

The present invention is described with reference to the attached figures, wherein like reference numbers are used throughout the figures to designate similar or equivalent elements. The figures are not drawn to scale and they are provided merely to illustrate the present invention. Several aspects of the invention are described below with reference to example applications for illustration. It should be understood that numerous specific details, relationships, and methods are set forth to provide a full understanding of the invention. One having ordinary skill(s) in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

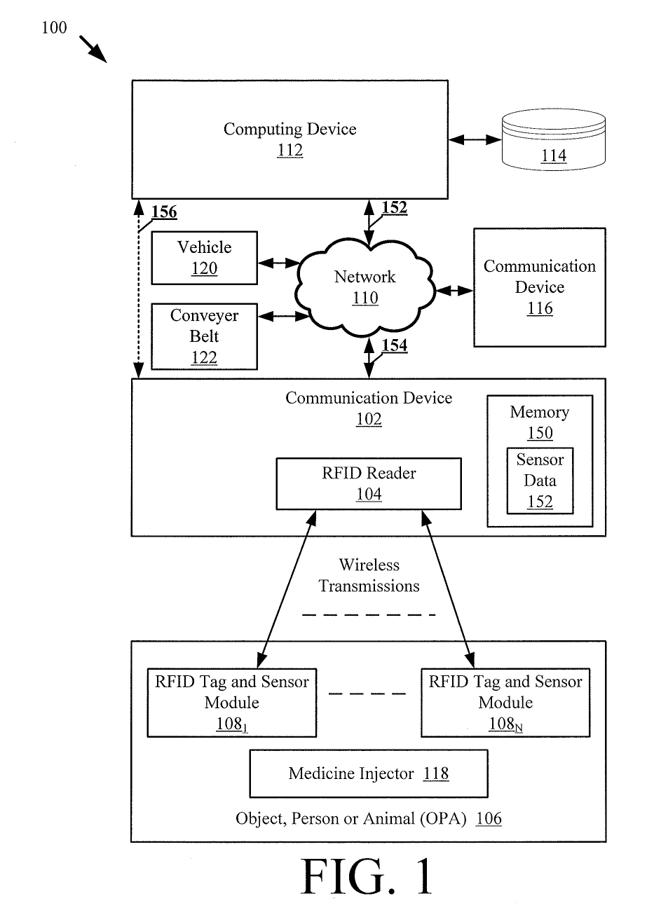

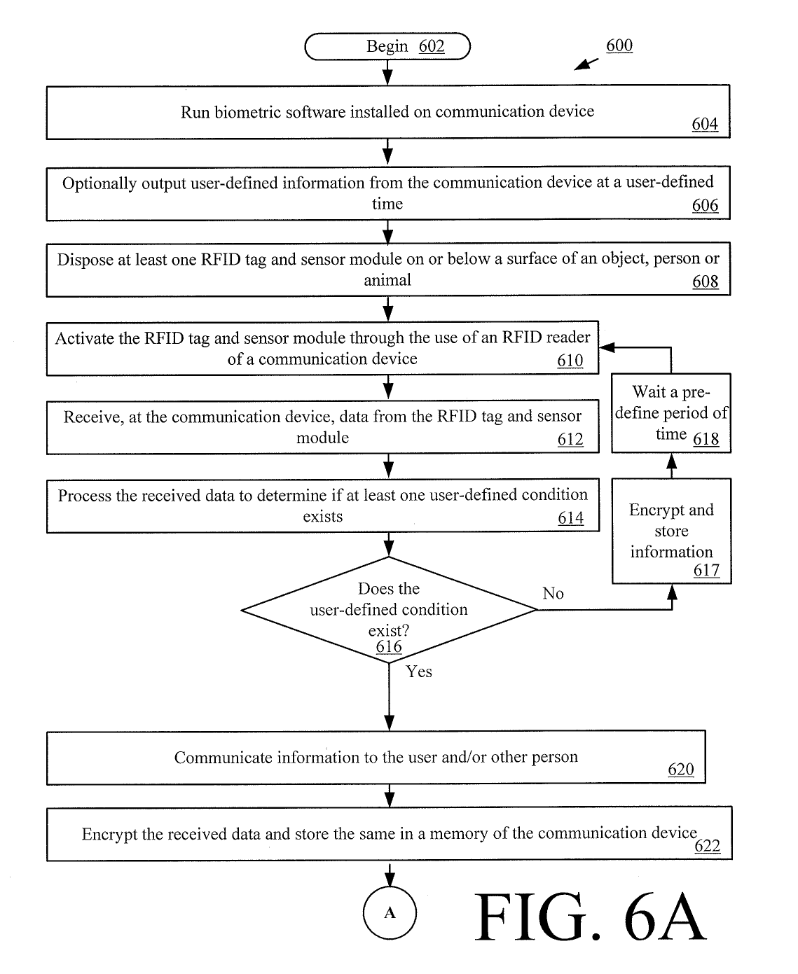

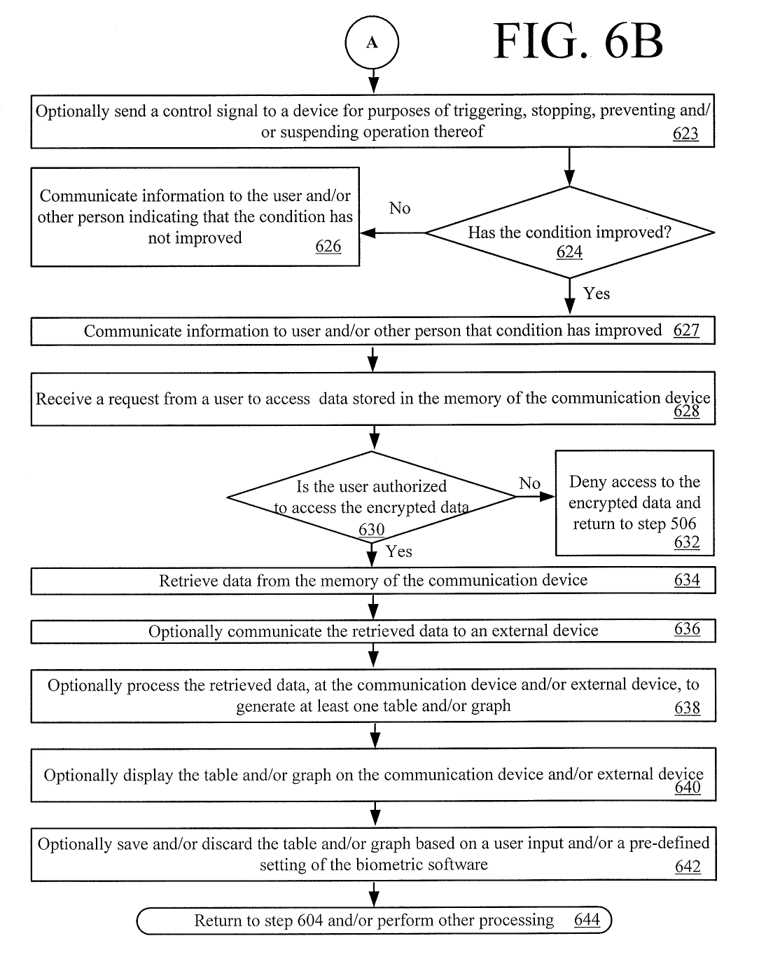

Embodiments of the present invention generally concern implementing systems and methods for monitoring characteristics of a person, object, animal and/or surrounding environment. Exemplary systems of the present invention will be described in detail below in relation to FIGS. 1-4. Exemplary methods of the present invention will be described in detail below in relation to FIGS. 5-6B. However, prior to discussing FIGS. 1-6B, a brief discussion of system embodiments of the present invention and their advantages is provided.

Radio Frequency Identification (RFID) Systems use a device known as an RFID tag. The RFID tag is generally attached to or placed in proximity to an environment, object, animal or person. The RFID tag can be “read” from some distance away, which distance can range from a few inches to several meters. In fact, some RFID tags can be read from even greater distances provided that there is an unobstructed path between the RFID tag and the RFID reader and the signal strength is strong enough.

RFID systems were originally develop mainly for tracking and locating an object, but have evolved to the point where they can be used to sense many different parameters. Those skilled in the art will appreciate that RFID tags will generally include one of three types. Active RFID tags are those which contain a battery and can autonomously transmit a signal when triggered to do so. A second type of RFID tag is a passive type. Passive RFID tags do not have a battery and will not autonomously generate a signal. Instead, a passive RFID tag requires an external source to generate a signal transmission from the RFID tag. Finally, there are also known in the art certain hybrid type RFID tags which are triggered into operation by an external source, but also utilize a battery.

The present invention can use any type of RFID tag including passive, active or hybrid type devices. In general, an RFID reader includes two basic parts: (1) a transceiver with a decoder; and (2) an antenna from the transceiver. The transceiver generates an RF signal that is communicated to the antenna. The transmitted signal from the antenna provides the means for communicating with the antenna and (at least in the case of a passive RFID) provides the energy needed for the RFID tag to communicate. When the RFID tag is exposed to a transmitted signal from the RF reader, it detects a coded “wake up” signal using a suitable RFID microchip. The RFID microchip transmits an RF signal containing certain information (e.g., a tag identifier) stored by the RFID tag. The signal from the RFID tag is then received by the RFID reader and decoded. If the RFID tag has a battery, then the battery can be used to generate a more powerful signal, thereby allowing the RFID tag to communicate over a greater range. RFID systems are generally well known in the art and therefore will not be discussed here in detail.

System embodiments of the present invention generally comprise customizable software application, an RFID reader and at least one RFID Tag and Sensor Module (RFID-TSM). An RFID-TSM includes an RFID tag (such as those described above) and one or more sensors for detecting physical, biological and chemical characteristics of a person, animal, object and/or surrounding environment. The customizable software application is installed and run on a microprocessor of a communication device (e.g., a smart phone). The RFID reader can be any suitable RFID reader known in the art. For example, the RFID reader can be: an iCarte™ RFID reader for an iPhone® which is available from Wireless Dynamics Inc. of Canada; or a ZR-PCMCIA RFID reader for a personal digital assistant which is available from TagSense Inc. of Massachusetts, United States. The RFID reader is disposed in or coupled to the communication device. The RFID-TSM also can be obtained from TagSense Inc. of Massachusetts, United States. The RFID-TSM is disposed on or coupled to the person, object and/or animal. The RFID-TSM can be a passive or active device. However, it should be noted that a passive RFID-TSM does not require a battery, and therefore is less cumbersome and less expensive as compared to an active RFID-TSM.

During operation of the system, the RFID-TSM detects one or more characteristics of the person, object, animal and/or surrounding environment. Such characteristics include, but are not limited to, blood alcohol levels, heart rates, glucose levels, pressures (e.g., blood pressure), temperatures, deceleration, motion, lack of motion, chemical hazards, biological hazards and radiological hazards. RFID-TSM may also be designed to detect health issues or illnesses of a person or animal. Various types of RFID-TSM devices suitable for sensing one or more of the above-listed characteristics can be obtained from TagSense Inc. of Massachusetts, GE Global Research of New York, Evigia Systems, Inc. of Missouri and other companies.

The RFID reader receives information from the RFID-TSM describing the sensed characteristic and a unique serial number of the RFID-TSM. Upon receipt of the information, the communication device processes the information to determine if at least one defined condition exists (e.g., a medical condition, an environmental hazard, intoxication and/or a contamination). The defined condition can be a user-defined condition. The defined condition can be any combination of user-defined conditions that have been combined using the “AND”/“OR” operators. If it is determined that the user-defined condition exists, then the communication device will automatically perform one or more actions. Such actions include, but are not limited to: communicating an audio message (e.g., an earcon), a text message, an email, an auditory icon or other indication (e.g., light, sound, icon or image) to a user and/or other person indicating that the defined condition exists; and sending a control signal to a device (e.g., a valve, a medicine injector, a vehicle and a conveyer belt) for triggering, stopping, preventing and/or suspending operation of the device. The term “earcon”, as used herein, refers to a structured sound pattern used to represent a specific item, event or voice message. Notably, earcons could be synthesized sounds or verbal speech. For instance, an earcon could be a pre-recording of the person's voice providing some additional instructions and/or warning. The pre-recording is recorded during the user interactive session or setup. In addition, earcons can be used in different combinations to create complex audio messages. The information from the RFID-TSM can be stored in a memory device of the communication device in a secure manner (e.g., in an encrypted format and/or in a physically secure or tamper proof enclosure). The communication device can restrict access to the stored information based on user identifications, passwords and/or access levels.

The present invention has various advantages. For example, the present invention advantageously utilizes passive type RFID-TSMs that do not require batteries. As such, the present invention is less cumbersome, less expensive and more reliable as compared to conventional monitoring/detection systems. Still the invention is not limited in this regard and may also use active or hybrid type RFID tags. The present invention also provides a means for tracking physical, biological and chemical characteristics of an object, person, animal and/or surrounding environment; securing data from unauthorized access; and/or facilitating the customization of application specific features in accordance with a particular need. The present invention further provides an automated means for controlling the operation of a device (e.g., a valve, a medicine injector, a vehicle, or machinery such as a conveyer belt) at a defined time and/or upon the existence of a defined condition. The defined time can be a user-defined time. Similarly, the condition can be a user-defined condition.

As evident from the above discussion, the systems and methods of the present invention can be used in a variety of applications. Such applications include, but are not limited to, healthcare applications relating to humans and animals, military applications, food processing applications, athletic applications, environmental hazard applications, traffic safety applications, product manufacturing applications and device control applications. The present invention will now be described in relation to FIGS. 1-6B.

### Exemplary Systems Implementing the Present Invention

Referring now to FIG. 1, there is provided a schematic illustration of an exemplary system 100 that is useful for understanding the present invention. The system 100 is generally configured to facilitate the monitoring of characteristics of a person, object, animal and/or surrounding environment. As such, the system 100 comprises communication devices 102, 116, a computing device 112, RFID-TSMs 108₁, 108₂, . . . , 108_{N}, a database 114 and a network 110.

The computing device 112 can include, but is not limited to, a general purpose computer located in an unsecure or secure environment. An unsecure environment is one where there are no access restrictions to the computing device 112. A secure environment is one where there are restrictions to the access of the computing device 112. In some scenarios, the access restrictions can be achieved by restricting access to a room or area in which the computing device 112 is located to authorized persons. In this regard, the computing device 112 can be located in a home, a business facility, a government facility, a health facility, a public service agency facility, an educational building or a vehicle.

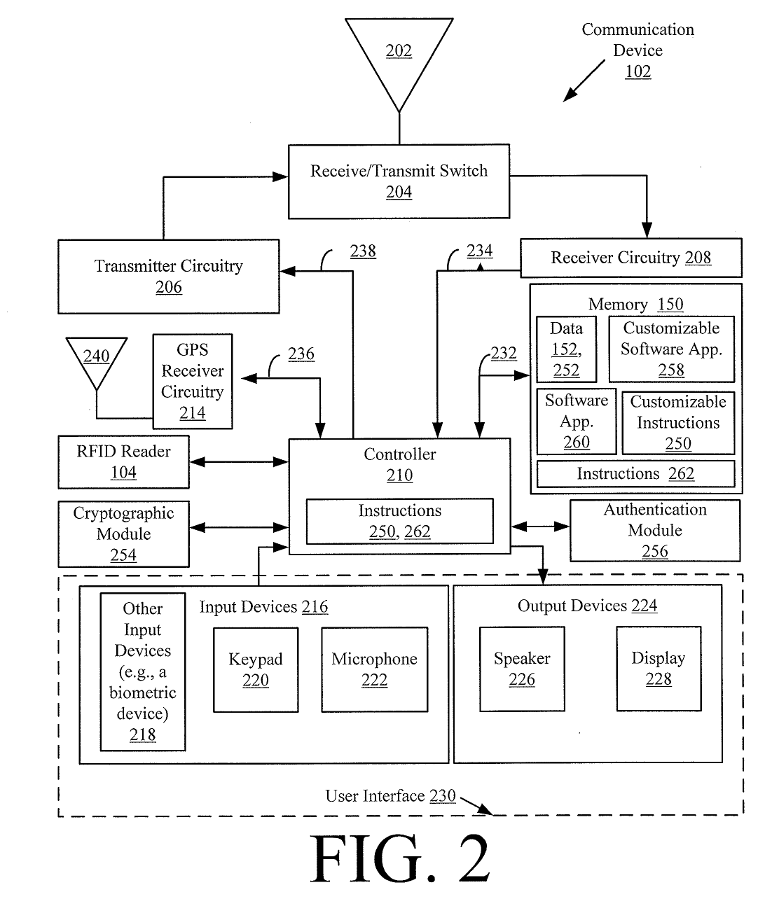

As shown in FIG. 1, the computing device 112 is communicatively coupled to the communication device 102 via a direct (or wired) link 150 and/or an indirect (or wireless) communication link 152, 154 through the network 110. For example, if the computing device 112 is located in a home, then the computing device 112 may be used to install a software application (e.g., a customizable software application 258 of FIG. 2) on the communication device 102. In this scenario, the devices 102, 112 can be communicatively coupled via the direct link 150. Alternatively, the devices 102, 112 can be communicatively coupled via the indirect (or wireless) communication link 152, 154. The links 150, 152, 154 can be trusted links configured to communicate data in a secure manner (e.g., in an encrypted format).

The communication device 102 has an RFID reader 104 disposed therein or coupled thereto via a peripheral device interface (not shown). RFID readers 104 are well known to persons skilled in the art, and therefore will not be described in detail herein. The communication device 102 is communicatively coupled to the communication device 116 via a communication path through the network 110. The communication path can be a trusted communication path configured to communicate data in a secure manner (e.g., in an encrypted format).

Each of the communication devices 102, 116 can include, but are not limited to, smart phones, Personal Digital Assistants (PDAs), mobile telephones, cellular phones, radios and other portable communication devices. The phrase “smart phone”, as used herein, refers to a combined communication terminal of a cellular telephone and a computer. Thus, a smart phone can run applications as a thick client with application(s) stored directly in the phone or as a thin client with application(s) stored remotely at a computing device 112 or data center. The smart phone can also access the world wide web (e.g., the Internet), send emails, receive emails, fax documents and perform word processing.

The RFID-TSMs 108₁, 108₂, . . . , 108_{N} are disposed in or on a surface (not shown) of an Object, Person or Animal (OPA) 106. In this regard, each RFID-TSM 108₁, 108₂ (not shown), . . . , 108_{N} can include a means for removably securing it to the OPA 106. Such means includes, but is not limited to, an adhesive, a strap, a band and a belt.

As noted above, each of the RFID-TSMs 108₁, 108₂, . . . , 108_{N} can be a passive device or an active device. If an RFID-TSM 108₁, 108₂, . . . , 108_{N} is an active device, then it will include an internal power source (e.g., a battery). If the RFID-TSM 108₁, 108₂, . . . , 108_{N} is a passive device, then it will not include a battery. In this scenario, the RFID-TSM 108₁, 108₂, . . . , 108_{N} is a passive device that is powered by Radio Frequency (RF) signals received from an RFID reader 104.

Each of the RFID-TSMs 108₁, 108₂, . . . , 108_{N} is configured to detect characteristics of the OPA 106 and/or surrounding environment (not shown) thereof. This detection can involve monitoring and collecting information about the physical, biological and chemical characteristics of the OPA 106. The detection can also involve monitoring and collecting information about the physical, biological and chemical characteristics of the surrounding environment. In response to an RF signal received from the RFID reader 104, the RFID-TSM 108₁, 108₂, . . . , 108_{N} can communicate information to the communication device 102. This information can include, but is not limited to, identification information, information relating to the physical, biological and chemical characteristics of the OPA 106 and/or surrounding environment. The identification information can include, but is not limited to, information identifying a particular RFID-TSM 108₁, 108₂, . . . , 108_{N} and/or OPA 106.

At the communication device 102, the information is processed using a customizable software application (e.g., the customizable software application 258 of FIG. 2) to determine if a defined condition exists. In some embodiments, the defined condition can be a user-defined condition. If the defined condition does not exist, then the communication device 102 will store the information in memory or storage device 150 provided as part of the communication device 102. The data is preferably stored in a secure manner (e.g., in an encrypted form and/or in a tamper proof enclosure). However, if the defined condition does exist, then the communication device 102 will also store the information in its internal memory 150 as previously described. The communication device 102 can further perform one or more of the following defined actions: output an audio message (e.g., an earcon), a visual message, a text message and/or other indicator (e.g., light, sound, icons and images) indicating that the condition exists; communicate a message indicating that the condition exists to one or more user-specified remote device (e.g., a communication device 116 and/or computing device 112); and send a control signal to a user-specified device (e.g., a valve, a medicine injector 118, a vehicle 120 and/or a conveyer belt 122) for triggering, stopping, preventing and/or suspending operation of the device. In some embodiments, the defined actions can be user-defined actions.

At some future time, the information stored in communication device 102 can be accessed for purposes of viewing and analyzing the same. In this regard, the communication device 102 can be configured to restrict access to the stored information based on a user identifier, a password, at least one static biometric feature and/or access rights of the user or other user-authorized person. The static biometric features can include, but are not limited to, a finger print, blood type, DeoxyriboNucleic Acid (DNA), iris, retina, tissue and other biometric features unique to an individual which do not change over time.

In some scenarios of the present invention, the access restriction is achieved using an authentication technique. Authentication techniques are well known to those skilled in the art, and therefore will not be described herein. Once a user has been authenticated, the communication device 102 will retrieve all or a portion of the stored information from its memory 150. The retrieved information can be processed by the communication device 102 for displaying one or more tables and/or graphs to the user. The graphs and/or tables can be displayed to the user via a display screen of a communication device 102. The graphs and/or tables can also be displayed to a user-authorized person on one or more devices 112, 116 external to the communication device 102. The external device 112, 116 on which to display the graphs and/or tables can be user-specified. The tables and/or graphs can be stored in the memory of the communication device 102, 116 and/or computing device 112. Alternatively, the tables and/or graphs can be discarded after the user and/or other user-authorized person has finished viewing the same. The table/graph display features of the present invention will become more evident as the discussion progresses.

Referring now to FIG. 2, there is provided a more detailed block diagram of the communication device 102 that is useful for understanding the present invention. The communication device 116 of FIG. 1 can be generally similar to the communication device 102, albeit different in some ways (e.g., absent of an RFID reader and associated customizable software application 258). As such, the following discussion of the communication device 102 is sufficient for understanding the communication device 116. Notably, the communication device 102 may include more or less components than those shown in FIG. 2. However, the components shown are sufficient to disclose an illustrative embodiment implementing the present invention.

The hardware architecture of FIG. 2 represents one embodiment of a representative communication device 102 configured to facilitate the monitoring of characteristics of a person, object, animal and/or surrounding environment. In this regard, the communication device 102 includes an RFID reader 104, a cryptographic module 254, an authentication module 256 and a biometric device 218. The RFID reader 104 is generally configured to emit radio waves to RFID tags (e.g., RFID tag and sensor modules 108₁, . . . , 108_{N} of FIG. 1) within communications range thereof. Upon receiving the signal, the RFID tag sends back its data to the RFID reader 104. The cryptographic module 254 performs encryption and decryption operations. The authentication module 256 obtains authentication information and authenticates a person based on the authentication information (e.g., an identifier and password). The biometric device 218 obtains static biometric information, such as a finger print or iris scan.

The communication device 102 also comprises an antenna 202 for receiving and transmitting Radio Frequency (RF) signals. A receive/transmit (Rx/Tx) switch 204 selectively couples the antenna 202 to the transmitter circuitry 206 and receiver circuitry 208 in a manner familiar to those skilled in the art. The receiver circuitry 208 demodulates and decodes the RF signals received from a network (e.g., the network 110 of FIG. 1) to derive information therefrom. The receiver circuitry 208 is coupled to a controller (or microprocessor) 210 via an electrical connection 234. The receiver circuitry 208 provides the decoded RF signal information to the controller 210. The controller 210 uses the decoded RF signal information in accordance with the function(s) of the communication device 102.

The controller 210 also provides information to the transmitter circuitry 206 for encoding and modulating information into RF signals. Accordingly, the controller 210 is coupled to the transmitter circuitry 206 via an electrical connection 238. The transmitter circuitry 206 communicates the RF signals to the antenna 202 for transmission to an external device (e.g., a node of a network 110 of FIG. 1) via the Rx/Tx switch 204.

An antenna 240 is coupled to Global Positioning System (GPS) receiver circuitry 214 for receiving GPS signals. The GPS receiver circuitry 214 demodulates and decodes the GPS signals to extract GPS location information therefrom. The GPS location information indicates the location of the communication device 102. The GPS receiver circuitry 214 provides the decoded GPS location information to the controller 210. As such, the GPS receiver circuitry 214 is coupled to the controller 210 via an electrical connection 236. The controller 210 uses the decoded GPS location information in accordance with the function(s) of the communication device 102. For example, the GPS location information can be linked to the sensor data and used to determine a location of an RFID-TSM (e.g., the RFID-TSM 108₁, 108₂ (not shown), . . . , 108_{N} of FIG. 1).

The controller 210 stores the decoded RF signal information and the decoded GPS location information in a memory 150 of the communication device 102. Accordingly, the memory 150 is connected to and accessible by the controller 210 through an electrical connection 232. The memory 150 may be a volatile memory and/or a non-volatile memory. For example, the memory 150 can include, but is not limited to, a Random Access Memory (RAM), a Dynamic Random Access Memory (DRAM), a Static Random Access Memory (SRAM), Read-Only Memory (ROM) and flash memory. The memory 150 may also comprise unsecure memory and/or secure memory. The phrase “unsecure memory”, as used herein, refers to memory configured to store data in a plain text form. The phrase “secure memory”, as used herein, refers to memory configured to store data in an encrypted form and/or memory having or being disposed in a secure or tamper-proof enclosure. The memory 150 can also be used to store various other types of information therein, such as medical records, static biometric data, medical dictionary, reference guides, drug interaction information, authentication information and cryptographic information.

As shown in FIG. 2, one or more sets of instructions 250, 262 are stored in the memory 150. The instructions 250 include customizable instructions. The instructions 262 include non-customizable instructions. The instructions 250, 262 can also reside, completely or at least partially, within the controller 210 during execution thereof by the communication device 102. In this regard, the memory 150 and the controller 210 can constitute machine-readable media. The term “machine-readable media”, as used here, refers to a single medium or multiple media that stores one or more sets of instructions 250, 262. The term “machine-readable media”, as used here, also refers to any medium that is capable of storing, encoding or carrying the set of instructions 250, 262 for execution by the communication device 102 and that causes the communication device 102 to perform one or more of the methodologies of the present disclosure.

The controller 210 is also connected to a user interface 230. The user interface 230 is comprised of input devices 216, output devices 224 and software routines (not shown in FIG. 2) configured to allow a user to interact with and control software applications (e.g., customized software application 258 and other software applications 260) installed on the communications device 102. Such input and output devices include, but are not limited to, a display 228, a speaker 226, a keypad 220, a directional pad (not shown in FIG. 2), a directional knob (not shown in FIG. 2), a microphone 222 and other input device 218 (e.g., a push-to-talk button and/or a biometric device). The display 228 may be designed to accept touch screen inputs. As such, user interface 230 can facilitate a user-software interaction for launching applications (e.g., customized software application 258 and other software applications 260) installed on the communications device 102. The user interface 230 can facilitate a user-software interactive session for authenticating and accessing data (e.g., data 252) stored in the memory 150.

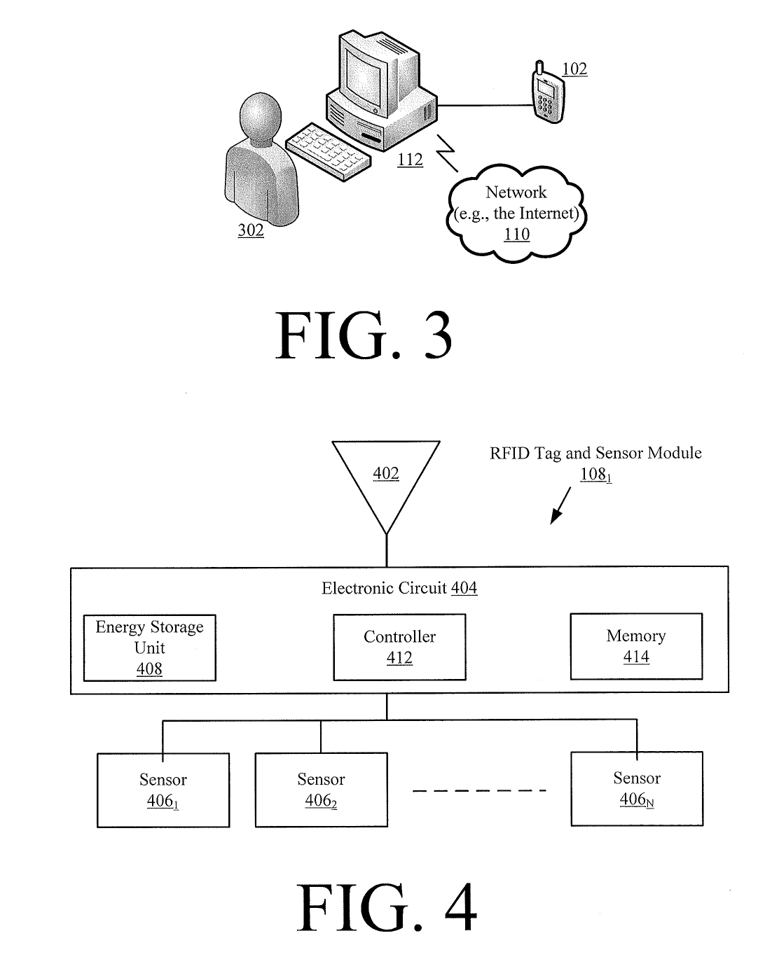

The display 228, keypad 220, directional pad (not shown in FIG. 2) and directional knob (not shown in FIG. 2) can collectively provide a user with a means to initiate one or more software applications 258, 260 or functions of the communication device 102. The customizable software applications 258 can facilitate the provision of health monitoring services, medical alert services, environment hazard detection services, traffic safety services, product manufacturing services, contamination detection services, device control services and other types of services to the user using the communication device 102. As such, the customizable software applications 258 are operative to facilitate the performance of authentication operations, data communication operations, data processing operations and device control operations. A method for customizing the customizable software applications 258 will be described below in relation to FIG. 5. However, it should be noted that a person can customize the software to meet their specific needs during the user-software interactive session directly on the communication device 102. Alternatively, the customizable software application 258 can be customized using a general purpose computer (e.g., the computing device 112 of FIG. 1) connected to a network (e.g., the network 110 of FIG. 1) as shown in FIGS. 1 and 3.

The data communication operations can include, but are not limited to, generating RF signals, communicating RF signals to RFID tag and sensor modules (e.g., modules 108₁, . . . , 108ₙ of FIG. 1), receiving information from the RFID tag and sensor modules, and communicating information to external devices (e.g., devices 112 and 116-122 of FIG. 1). The information received at the communication device 102 can include, but is not limited to, information relating to: the physical, biological and chemical characteristics of an object, person, animal (e.g., OPA 106 of FIG. 1) and/or surrounding environment. The information communicated from the communication device 102 can include, but is not limited to: an auditory message (e.g., a pre-recorded voice message or earcon), a visual message (e.g., a text message or email) and/or other indicator (e.g., light, sound, icon and/or image); and a command for triggering, stopping, preventing and/or suspending operation of a device (e.g., a medicine injector 118, a vehicle 120 and/or a conveyer belt 122 of FIG. 1). The messages and other indicators can include, but is not limited to, the following information: an identifier (e.g., a name), a location (e.g., an address and/or GPS information), medical information (e.g., allergies, blood type and illnesses), physical information (i.e., movement or lack of movement), dynamic biometric information (e.g., heart rate and glucose level), chemical information, time of day and information indicating the existence and type of a condition (e.g., environmental hazard, an intoxication and a contamination).

The data processing operations can include, but are not limited to: processing information received from RFID-TSMs to determine if one or more defined conditions exist; record and access data stored in an internal memory of the communication device 102; encrypting and decrypting data; generating tables and/or graphs using data received from RFID tag and sensor modules; and discarding data, tables and/or graphs. The device control operations can include, but are not limited to control signal generation operations and control signal communication operations.

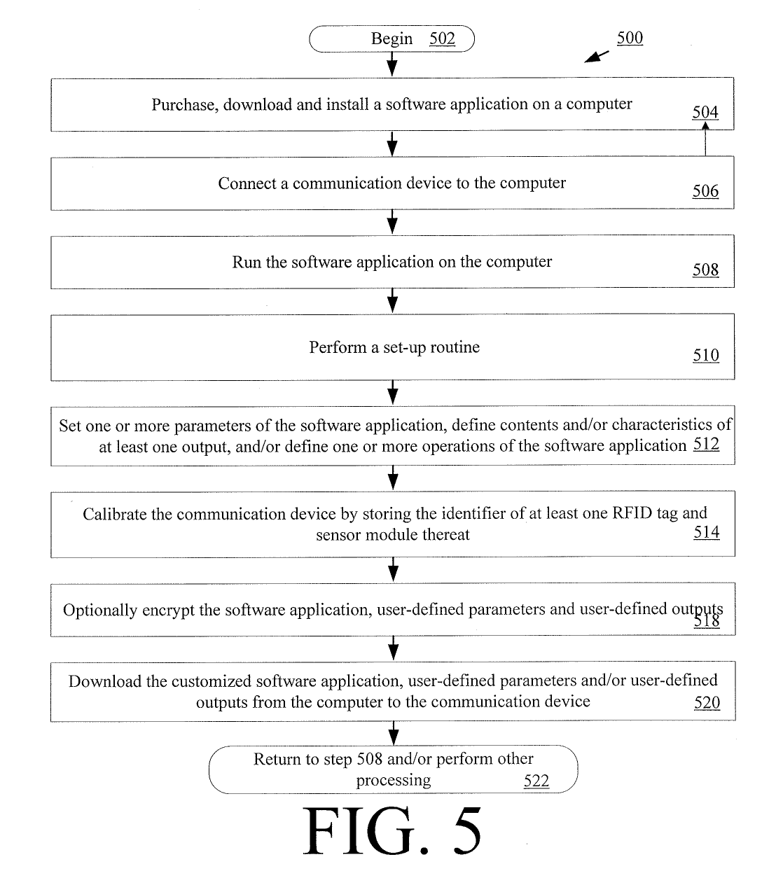

Referring now to FIG. 4, there is provided a detailed block diagram of an RFID-TSM 108₁ of FIG. 1. Each of the other RFID-TSMs 108₂, . . . , 108_{N} of FIG. 1 can be similar to the RFID-TSM 108₁, albeit different in some ways (e.g., include different tag identifiers and types of sensors). As such, the following description of RFID-TSM 108₁ is sufficient for understanding the RFID-TSMs 108₂, . . . , 108_{N} of FIG. 1. Notably, the RFID-TSM 108₁ may include more or less components than those shown in FIG. 4. However, the components shown are sufficient to disclose an illustrative embodiment implementing the present invention.

The hardware architecture of FIG. 4 represents one embodiment of a representative RFID-TSM 108₁ configured to facilitate the monitoring of characteristics of a person, object, animal and/or surrounding environment. In this regard, the RFID-TSM 108₁ includes an antenna 402, an electronic circuit 404 and at least one sensor 406₁, 406₂, . . . , 406_{N}. The electronic circuit 404 includes an energy storage unit 408, a controller 412 and memory 414. Although not shown in FIG. 4, the electronic circuit 404 can also include a secure (or tamper-proof) enclosure and a cryptographic module configured for encrypting and decrypting data. As such, the RFID-TSM 108₁ may be configured to secure data contained therein. The RFID-TSM 108₁ can be disposable or non-disposable.

### Exemplary Methods Implementing the Present Invention

Referring now to FIG. 5, there is provided a flow diagram of an exemplary method 500 for customizing a customizable software application (e.g., the customizable software application 258 of FIG. 2) of the present invention. The customizable software application 258 is generally configured to facilitate the monitoring of characteristics of a person, object, animal and/or surrounding environment. Notably, FIG. 5 describes the scenario where the customizable software application 258 is customized using a computer (e.g., computing device 112 of FIG. 1) external to a communication device (e.g., communication device 102 of FIG. 1) on which the customizable software application 258 is to be installed. Embodiments of the present invention are not limited in this regard. For example, the software application can alternatively be customized directly on the communication device 102 (e.g., a smart phone).

As shown in FIG. 5, the method 500 begins at step 502 and continues with step 504. In step 504, a customizable software application 258 is purchased and downloaded from a software provider. The customizable software application 258 is then installed on the computer 112. In a next step 506, a communication device 102 is connected to the computer 112 via a peripheral device interface (not shown).

After the customizable software application 258 is installed on the computer 112, step 508 is performed where the software application is executed. A set-up routine (or user-software interactive session) is performed in step 510. The set-up routine can generally involve the provision of a series of intuitive step-by-step questions and/or instructions. In certain scenarios, the questions can ask for a name, address, phone number, a facial picture, an iris picture, an age, medical information (e.g., static biometric data such as blood type, allergies and illnesses) and/or a password. Upon completion of the set-up routine, step 512 is performed where one or more parameters of the customizable software application 258 are set by the user. Also, the contents and/or characteristics of one or more outputs of the communication device 102 are defined in step 512. Further, one or more operations of the customizable software application 258 are defined by the user in step 512.

The parameters can include, but are not limited to, data type parameters (e.g., types of data that are to be recorded), parameters indicating under what conditions certain actions are to be triggered (e.g., threshold parameters), time parameters (e.g., a period of time indicating how often particular types of data will be recorded by the communication device 102), contact information parameters (e.g., names, titles, phone numbers and email addresses), data access parameters (e.g., people that can access data and what types of data the people can access), software customization restriction parameters (e.g., people authorized to change the software), device information parameters (e.g., names, addresses and device descriptions), cryptographic parameters, authentication parameters (e.g., user names, passwords and static biometric data), data display parameters, data storage parameters, message parameters (e.g., message type, contents and intended recipient) and indicator parameters (e.g., indicator types, contents and intended recipient). Notably, the condition triggering parameters can be provided to the user by a third party, such as a doctor.

The outputs of the communication device 102 can include, but are not limited to, voice messages, emails, text messages, earcons, sounds, icons, images, light emissions and vibrations. Each of the voice messages, emails, text messages and earcons can include information relating to a particular condition and what should be performed to improve the condition. The user can specify the types of outputs desired and to whom each output is to be directed. For example, a particular output can be directed to the user himself, a doctor, a nurse, an emergency response agency, a public service agency, an employee, a family member, a pet owner and/or a friend.

The operations can include, but are not limited to: automatically outputting messages to the user at particular times of the day, week, month or year; periodically obtaining data from an RFID tag and sensor module; encrypting data prior to or subsequent to storage and/or communication thereof; allowing or denying requests to access data; outputting data in user-defined formats (e.g., graph and table formats); discarding data at particular times; determining if a condition exists based on one or more user-defined parameters (e.g., thresholds); and performing one or more user-defined operations if one or more conditions exists.

After completing step 512, step 514 is performed where the communication device (e.g., the communication device 102 of FIGS. 1-2) is calibrated by storing an identifier of one or more RFID-TSMs therein. Notably, the communication device 102 will only process information received from the RFID-TSMs for which it has an identifier. The identifier for each RFID-TSM is input during the user interactive session or start-up routine.

In optional step 518, the customizable software application 258, user-defined parameters and/or user-defined outputs are encrypted so that they can be communicated to the communication device 102 in a secure manner. Thereafter, step 520 is performed where the customizable software application 258, user-defined parameters and/or user-defined outputs are communicated from the computer 112 to the communication device 102 for installation thereon. Next, step 522 is performed where the method 500 returns to step 508 and/or other processing is performed. Notably, the above described method 500 can be performed each time a new RFID-TSM is added to the system (e.g., system 100 of FIG. 1), and/or each time the user wants to add or change a customizable feature of the customizable software application 258.

Referring now to FIGS. 6A-6B, there is provided a flow diagram of an exemplary method 600 for monitoring conditions of a person, object, animal and/or surrounding environment using a customizable software application such as that described above in relation to FIGS. 2 and 5. As shown in FIG. 6A, the method 600 begins with step 602 and continues with step 604. In step 604, a customizable software application (e.g., customizable software application 258 of FIG. 2) installed on a communication device (e.g., communication device 102 of FIG. 1) is run. Thereafter, user-defined information is output from the communication device 102 at a user-defined time. For example, the communication device 102 (e.g., a smart phone) may alert a user when it is time to take his or her medication. The alert can be in the form of a voice message (e.g., a earcon), a text message, sound, vibration, an icon display or a light emission from the communication device 102. An earcon can also provide information explaining how to take the medication.

In step 608, one or more RFID-TSMs (e.g., RFID-TSMs 108₁, . . . , 108_{N} of FIGS. 1 and 4) are disposed on and/or below a surface of an object, person or animal (e.g., OPA 106 of FIG. 1). Although, step 608 is shown to occur after steps 604 and 606, the method 600 is not limited in this regard. For example, step 608 can be performed prior to, subsequent to and/or concurrent with steps 604 and/or 606.

Next, at least one of the RFID-TSMs 108₁, . . . , 108_{N} is activated in step 610 through the use of an RFID reader (e.g., RFID reader 104 of FIGS. 1-2) of the communication device 102. Subsequent to being activated, the RFID-TSM communicates information to the RFID reader 104. The information is received at the RFID reader 104 in step 612. The information can include, but is not limited to, information relating to sensed physical, biological and chemical characteristics of a person, animal, object and/or surrounding environment.

The information is processed at the communication device 102 in step 614 to determine if a defined condition exists. For example, it can be determined whether or not one or more sensed physical, biological and chemical characteristics exceed a threshold value, thereby indicating that a medical condition, contamination, intoxication or environmental hazard exists. If it is determined that the defined condition does not exist [616:NO], then steps 617 and 618 are performed. In step 617, the information received from the RFID-TSM is stored in an internal memory of the communication device 102. As noted above, the information can be stored in a secure manner, i.e., in an encrypted format and/or within a secure or tamper-proof enclosure. In step, 618, the method 600 waits a defined period of time, which can be user-defined. After expiration of the defined period of time, the method returns to step 610. However, if it is determined that the defined condition does exist [616:YES], then the method 600 continues with step 620 and 622. Although, steps 620 and 622 are shown to occur in a particular order, the method 600 is not limited in this regard. For example, step 622 can be performed prior to, subsequent to and/or concurrent with step 620.

In step 620, information is communicated to the user and/or other person (e.g., a friend, family member, a pet owner, emergency responder, nurse, doctor, police and/or employee). For example, if it is determined that a particular medical condition exits, then an indication or alert can be communicated to the user via an output device (e.g., output device 226, 228 of FIG. 2) of the communication device 102. Also, information can be communicated to one or more external devices of a friend, family member and/or medical personnel. This information can include, but is not limited to, a name, address, a facial picture, dynamic biometric information, GPS location information, an age, static medical information (e.g., blood type and allergies) and an identifier of the existing condition.

In step 622, the information received from the RFID-TSM 108₁, . . . , 108_{N} can be stored in an internal memory 150 of the communication device 102. As noted above, the information can be stored in a secure manner, i.e., in an encrypted format and/or within a secure or tamper-proof enclosure. Upon completing step 622, the method 600 continues with an optional step 623 of FIG. 6B.

Referring now to FIG. 6B, optional step 623 involves sending a control signal to a device for purposes of triggering, stopping, preventing and/or suspending one or more operations thereof. For example, the communication device 102 can communicate a control signal for preventing operation of a vehicle (e.g., vehicle 120 of FIG. 1) when a user is determined to be intoxicated. Also, the communication device 102 can communicate a control signal for suspending, stopping or preventing operation of a conveyor belt (e.g., conveyor belt 122 of FIG. 1) when it is determined that food is contaminated. Further, the communication device can communicate a control signal to a valve or medicine injector (e.g., medical injector 118 of FIG. 1) when it is determined that a particular medical condition exists.

In a next optional step 624, it is decided whether the condition has improved. If the condition has not improved [624:NO], then step 626 is performed where information is communicated to the user and/or other person. The information can indicate that the condition has not improved. The information can also include recently sensed dynamic biometric data. If the condition has improved [624:YES], then step 627 is performed when information is communication to the user and/or other person. The information can indicate that the condition has improved.

In a next step 628, a request to access stored data is received at the communication device 102. In response to the request, step 630 is performed where the communication device 102 determines if the user is authorized to access the stored data. If the user is not authorized to access the data [630:NO], then the request is denied in step 632. However, if the user is authorized to access the stored data [630:YES], then the data is retrieved from the memory 150 of the communication device 102 in step 634.

Thereafter, steps 636-642 are performed. In step 636, the retrieved data can be communicated to an external device (e.g., the devices 112, 116 of FIG. 1). In step 638, the retrieved data is processed at the communication device 102 (e.g., a smart phone) and/or external device to generate one or more tables and/or graphs. In step 640, the table(s) and/or graph(s) are displayed on the communication device 102 and/or external device. In step 642, the table(s) and/or graph(s) are saved or discarded based on a user input and/or user-defined setting of the customizable software application 258. Upon completing step 642, step 644 is performed where the method 600 returns to step 604 or other processing is performed.

### Exemplary Applications of the Present Invention

Notably, the above described system 100 and methods 500, 600 can be used in a variety of applications. Such applications include, but are not limited to, healthcare applications relating to humans and animals, military applications, food processing applications, athletic applications, environmental hazard applications, traffic safety applications, product manufacturing applications and device control applications. Exemplary situations where the system 100 and methods 500, 600 can be used are provided below that are useful for understanding the present invention.

### Example 1

A person visits with a doctor. During said visit, the person shares his dynamic biometric data (e.g., blood pressure, temperature, heart rate, etc . . . ) stored on his or her communication device 102 with the doctor by connecting the communication device 102 in to an interface (not shown in FIGS. 1-6B) at the doctor's office. The interface is coupled to a computing device 112. The dynamic biometric data includes data obtained over a period of time, such as an hour, a day, a week, a month or a year. The computer displays the dynamic biometric data to the doctor in a particular format (e.g., a table or graph format). Based on the displayed information, the doctor decides how to diagnose and/or treat the patient. Notably, the computing device 112 may or may not store the dynamic biometric data based on user-defined settings of the customized software application 258 running on the communication device 102.

The ability to share dynamic biometric data with a doctor in the above described manner saves time at the doctor's office. For example, rather than having a nurse perform various tasks to obtain dynamic biometric information about the person at the time of the visit, the person can simply show the doctor measurements of their biometric characteristics over a period of time. Also, the ability to share the dynamic biometric data can facilitate improved diagnosis and treatment of medical conditions. For example, there may be critical information that can only be discovered by showing the doctor personal dynamic biometric data sampled over a long period of time which the doctor would miss simply by taking one sample during the office visit.

### Example 2

Many senior citizens are currently using a medic alert device which they wear around their neck at all times. If a senior citizen activates the medic alert device, then a medic alert company will call the senior citizen to see if he or she is in need of assistance. If the call is not answered, then an ambulance is sent to the home of the senior citizen without knowing anything about the senior citizen (i.e., name, age, known medical condition, allergies, etc . . . ) or dynamic biometric data over a period of time. Often ambulances are sent to the senior citizens home under false alarm conditions.

With the present invention, there would be no false alarms such as those which occur with the above described conventional medic alert devices. The present invention provides a medical alert system that can be customized by a senior citizen (or close relative or doctor) to automatically call an ambulance if their heart rate or glucose level drops below a certain level. Furthermore, the present invention could be customized to send dynamic biometric data recorded over the past minute, hour or day directly to the ambulance team so that they known what to expect when they arrive at the senior citizen's house. The provision of such biometric information to the ambulance team saves time, and possibly the life of the senior citizen.

One can appreciate that if the senior citizen is unconscious, then he or she would not be able to activate the medic alert device. However, in this scenario, the present invention continues to record dynamic biometric data when the senior citizen is unconscious. In effect, the present invention would detect when a medical condition exists and automatically alert medical responders. The present invention would also provide the medical responders with relevant biometric information about the senior citizen and the current GPS location of the senior citizen. The present invention would further provide the medical responders with the name and age of the senior citizen, as well as other important information, such as allergies to certain medications.

### Example 3

There is a need by the military for a smart device that is capable of transmitting dynamic biometric data of a soldier in need of emergency care to a military medical facility. The present invention provides such a smart device. For example, a soldier is in possession of the communication device 102 of the present invention. The soldier also has one or more RFID-TSMs 108₁, . . . , 108_{N} attached to himself or herself. If the solder is wounded in action such that he or she is loosing blood, then the communication device 102 detects that the soldier's heart rate and blood pressure are falling. If the communication device 102 determines that the heat rate and/or blood pressure falls below a certain level, then it communicates an alert message indicating the type of wound, static biometric data (e.g., blood type), dynamic biometric data, timestamp and/or GPS location information to a rescue team, medical responders of the military and/or the nearest military hospital.

### Example 4

There is a need by the military for a system that is capable of warning soldiers of any biological, chemical or radiological hazards in areas around them. The present invention provides such a system. For example, one or more RFID-TSMs 108₁, . . . , 108_{N} of the present invention are disposed on a vehicle 120 or object located within a particular range of the soldiers. Also, one or more first communication devices 102 of the present invention are disposed within a particular range of the vehicle and/or object. Further, each soldier or team of soldiers is in possession of a second communication device 116.

During operation, the first communication device 102 receives biological, chemical or radiological data from the RFID-TSMs 108₁, . . . , 108_{N}. The data is processed at the first communication device 102 to determine if one or more user-defined biological, chemical or radiological hazards exits. If a biological, chemical and/or radiological hazard exists, then an indication of said hazard will be output from the first communication device 102. For example, the first communication device 102 vibrates, emits lights, output audio and/or displays an icon, image or text message. Additionally or alternatively, the first communication device 102 calls the second communication device 116. In response to the call, the second communication device 116 rings using a user-defined ring tone. Thereafter, the soldier answers the call, whereby an earcon is output to the soldier. The earcon includes information indicating what was detected, how far the hazard is from his or her current position, and in what direction the hazard is from his or her current position.

### Example 5

The present invention may provide in-vehicle security and emergency services. For example, a communication device 102 of the present invention is disposed in a vehicle 120. A person in the vehicle 120 has at least one RFID-TSMs 108₁, . . . , 108_{N} disposed thereon or coupled thereto.

Let's assume that the person is hurt in a car accident such that he or she becomes unconscious. In this scenario, the communication device 102 and module 108₁, . . . , 108_{N} collectively operate to record dynamic biometric data while the person is unconscious. The communication device 102 also processes the dynamic biometric data to determine if a biological characteristic of the person is less than or greater than a user-defined threshold. If the biological characteristic is less than or greater than the user-defined threshold, then the communication device 102 performs certain user-defined operations. For example, the communication device 102 sends an emergency call to an emergency service agency (e.g., police, fire department and emergency medical technicians) providing the person's name, age and dynamic biometric information. The communication device 102 also sends GPS data to the emergency service agency. The communication device 102 further continues to send updated dynamic biometric data to representatives of the emergency service agency while they are traveling to the scene of the accident. In this way, the person's life could be saved because the emergency team is ready when they arrive at the accident site.

### Example 6

A person is diabetic, and therefore has to take insulin shots when his or her blood sugar is low. An RFID-TSMs 108₁, . . . , 108_{N} is disposed on the person sends dynamic biometric data to the persons smart phone 102 every five (5) minutes, thereby allowing the person to have a pseudo real-time measurement of his or her glucose level. If the glucose level falls below a level defined by the person's doctor, then the communication device 102 (e.g., a smart phone) outputs a warning or alert to the person. For example, the communication device 102 could provide a vibration, an emission of light, a sound, an earcon message, etc. An would tell the person what to do to alleviate their low glucose level. If after a user-defined period of time the glucose level does not improve, then the communication device 102 calls an ambulance and provide emergency medical technicians with information relating to the person's condition and location.

As a consequence of the automatic glucose level monitoring of the present invention, the person would no longer need to prick his or her finger at random times during the day to make a measurement of their glucose level. Also, the chance that the person going into shock is substantially reduced.

### Example 7

An RFID-TSMs 108₁, . . . , 108_{N} is disposed on a pet or zoo animal. A communication device 102 is disposed within a range of the module 108₁, . . . , 108_{N}. The owner of the pet or zoo keeper is in possession of a smart phone (e.g., communication device 102 of FIGS. 1-2).

In this scenario, the communication device 102 receives data relating to the health and status of the animal from the RFID tag and sensor module. The communication device 102 also calls the owner or zoo keeper's phone when a user-defined condition occurs. The communication device 102 also provides information about the health and status of the animal to the owner or zoo keeper's phone. As such, the owner or zoo keeper is able to monitor the health and status of the animal while they are away from the location of the animal.

### Example 8

An RFID-TSMs 108₁, . . . , 108_{N} is disposed on a person. A communication device 102 is disposed within a range of the module 108₁, . . . , 108_{N}. A communication device 116 is in the possession of a third party, such as a doctor, a family member, a police officer and emergency medical technician.

In this scenario, the communication device 102 receives data relating to the health and status of the person from the RFID-TSM 108₁, . . . , 108_{N}. The communication device 102 also calls the third party's communication device 116 when a first user-defined condition occurs (e.g., a drug allergy, drug interaction, drug overdose, flu infection, unconscious, alcohol intoxication, lack of motion and/or the person has fallen). The communication device 116 may also output a prescription for medication for certain medical illnesses. The prescription can be received electronically from a doctor. Alternatively, the prescription can be determined by the communication device 116 based on the person's medical history and dynamic biometric data. The communication device 102 may further send a control signal to a device for controlling the operations thereof. For example, a control signal can be sent to the person's vehicle 120 to prevent operation thereof. A control signal may be sent to a valve or medical injector 118 to inject a certain amount of medication into the person's body at the appropriate time determined by the controller 210 based on a user-defined set of customizable instructions 250 that was input during a start-up routine.

### Example 9

The present invention is used in food processing applications. For example, in a first food processing scenario, an RFID-TSM 108₁, . . . , 108_{N} is disposed on a conveyor belt. The RFID-TSM 108₁, . . . , 108_{N} is configured to detect chemical and biological characteristics of the conveyor belt 122 and/or food transported on the conveyor belt 122. If the module 108₁, . . . , 108_{N} is triggered by a stimulus, then the module 108₁, . . . , 108_{N} sends an alert to a nearby communication device 102 worn by a worker. In response to the alert, the communication device 102 outputs an indication to the worker and/or communicates a command signal for stopping or suspending operations of the conveyor belt 122.

In a second food processing scenario, the present invention is used to detect possible food contamination from RFID-TSMs 108₁, . . . , 108_{N} attached to food containers. Upon the detection of food contamination, the proper authorities are contacted and provided information about the container and contamination. The information about the container allows the authorities to trace the contamination back to its origin to prevent any further contamination.

### Example 10

The present invention can be used by athletes. For example, an RFID-TSMs 108₁, . . . , 108_{N} is coupled to an athlete. The sensor is configured to monitor the core temperature of the athlete. If the core temperature of the athlete exceeds or falls below a user-defined threshold value, then the communication device 102 (e.g., a smart phone) of the athlete will output an indicator or alert, such as a sound or an earcon message providing instructions on what to do.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for monitoring at least one dynamic characteristic, comprising:
performing a user interactive session by displaying a plurality of user interactive screens and receiving a user input to permit a user to select a set of parameters in a software application to control operations of a portable communication device, said set of parameters including
information to be output from said portable communication device,
at least one condition, that is determinable using data relating to said dynamic characteristic, under which said portable communication device is to output said information, and
identification of at least one external device that is intended to receive at least a portion of said information and is remote from said portable communication device;
collecting, by an RFID tag and sensor module (RFID-TSM) disposed on a body, said data relating to said dynamic characteristic;
communicating said data relating to said dynamic characteristic from said RFID-TSM to said portable communication device, said portable communication device comprising an RFID reader and said software application with said user selected set of parameters;
determining, at said portable communication device, if said condition exits by using said data relating to said dynamic characteristic, and said software application; and
in response to a determination that said condition exists, communicating at least a portion of said information to said external device.

2. The method of claim 1, wherein said portable communication device is a smart phone.

3. The method of claim 1, further comprising selecting said dynamic characteristic from the group consisting of a physical characteristic, a biological characteristic and a chemical characteristic.

4. The method of claim 1, further comprising selecting said condition from the group consisting of a medical condition, a hazardous condition, an intoxication and a mobility condition.

5. The method of claim 1, further comprising using an “AND”/“OR” operator to combine two or more of said conditions.

6. The method of claim 1, further comprising automatically recording data obtained from said RFID-TSM at said portable communication device on a periodic basis defined by a user during said user-interactive session.

7. The method of claim 1, further comprising storing said data in said portable communication device in an encrypted form.

8. The method of claim 1, further comprising storing said data in a tamper-proof enclosure of said portable communication device.

9. The method of claim 1, wherein said information communicated to said external device includes said data relating to said dynamic characteristic.

10. The method of claim 1, wherein said information communicated to said external device includes an alert message personalized by a user during said user-interactive session.

11. The method of claim 10, wherein said alert message includes at least one of an earcon message, an auditory message, an email message and a text message.

12. The method of claim 10, wherein said alert message includes at least one of a voice recording, personal contact information, static biometric data, a timestamp, location information, directives and instructions.

13. The method of claim 1, further comprising outputting from said communication device instructions how to improve said condition that has been determined to exist.

14. The method of claim 1, further comprising outputting from said communication device, at a time defined by a user during said user-interactive session, an indication to take medication.

15. The method of claim 1, wherein said information includes a command for controlling operations of said external device.

16. The method of claim 15, wherein said external device includes a valve, a medicine injector, a vehicle or machinery.

17. The method of claim 1, further comprising restricting access to said data to only persons identified by said consumer during said user-interactive session.

18. The method of claim 1, wherein said RFID-TSM is a passive RFID device.

19. A system, comprising:
at least one RFID tag and sensor module (RFID-TSM) disposed on a body, said RFID-TSM being configured to collect data relating to at least one dynamic characteristic of at least one of said body or a surrounding environment;
a smart phone comprising an RFID reader and a software application customized by a user during a user-interactive session, said smart phone being a portable device located within a communications range of said RFID-TSM and configured for:
receiving said data from said RFID-TSM;
determining if at least one condition exits using said data and said software application; and
in response to a determination that said condition exists, performing at least one operation using said software application, said operation involving communicating information to an external device remote from said smart phone;
wherein said condition, said operation, said information and said external device were defined by said user in said user-interactive session.

20. The system of claim 19, wherein said dynamic characteristic is selected from the group consisting of a physical characteristic, a biological characteristic and a chemical characteristic.

21. The system of claim 19, wherein said user-defined condition is selected from the group consisting of a medical condition, a hazardous condition, an intoxication and a mobility condition.

22. The system of claim 19, wherein said smart phone is further configured for using an “AND”/“OR” operator to combined two or more of said conditions.

23. The system of claim 19, wherein said smart phone is further configured for automatically recoding data obtained from said RFID-TSM on a periodic basis defined by said user during said user-interactive session.

24. The system of claim 19, wherein said smart phone is further configured for storing said data in an encrypted form.

25. The system of claim 19, wherein said smart phone is further configured for storing said data in a tamper-proof enclosure thereof.

26. The system of claim 19, wherein said information communicated to said external device includes an alert message personalized by said user during said user-interactive session.

27. The system of claim 26, wherein said alert message comprises at least one of an earcon message, an auditory message, an email message and a text message.

28. The system of claim 26, wherein said alert message comprises at least one of a voice recording, personal contact information, static biometric data, a timestamp, location information, directives and instructions.

29. The system of claim 19, wherein said smart phone is further configured to output instructions how to improve said condition that has been determined to exist.

30. The system of claim 19, wherein said smart phone is further configured to output, at a time defined by said user during said user-interactive session, an indication to take medication.

31. The system of claim 19, wherein said operation involves communicating, from said smart phone, a control signal for controlling operations of said external device.

32. The system of claim 31, wherein said external device includes a valve, a medicine injector, a vehicle or machinery.

33. The system of claim 19, wherein said smart phone is further configured for restricting access to said data to only persons identified by said user during said user-interactive session.

34. The system of claim 19, wherein said RFID-TSM is a passive RFID device.
